(19) United States
(12) Patent Application Publication
(10) Pub. No.: US 2008/0272303 A1
(43) Pub. Date: Nov. 6, 2008

(54) MOBILE FUEL ANALYSIS APPARATUS AND METHOD THEREOF

(75) Inventors: Han-Wen Chu, Hsinchu City (TW); Cheng-Chuan Lu, Hsinchu City (TW); Chun-Hsing Huang, Miaoli City (TW); Shin-Yi Fu, Miaoli County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/174,600

(22) Filed: Jul. 16, 2008

Related U.S. Application Data
(63) Continuation-in-part of application No. 11/641,575, filed on Dec. 19, 2006.

(30) Foreign Application Priority Data
Dec. 29, 2005 (TW) TW94147213

(51) Int. Cl. G01J 5/02

(52) U.S. Cl. 250/339.12

(57) ABSTRACT

The invention provides a method for determining fuel quality and ethanol content. A mobile fuel analysis apparatus including a vehicle is provided. A database includes near-infrared spectra of standard fuel from a plurality of suppliers to establish correlation between quality parameter and the spectra of the oils. A near-infrared spectrometer is equipped on the vehicle and transported to a fuel distribution point. A near-infrared spectrum of a fuel sample is collected from the fuel distribution point. The collected spectrum is compared to the near-infrared spectra in the database, and converted into corresponding quality parameters.

### CROSS REFERENCE TO RELATED APPLICATIONS

This application is a Continuation-In-Part of pending U.S. patent application Ser. No. 11/641,575, filed Dec. 19, 2006 and entitled “mobile fuel analysis apparatus and method thereof”.

This Application claims priority of Taiwan Patent Application No. 94147213, filed on Dec. 29, 2005, the entirety of which is incorporated by reference herein.

### BACKGROUND OF THE INVENTION

1. Field of the Invention

The invention relates to analysis of fuel, and in particular to a mobile near-infrared fuel analysis apparatus and a method for determining ethanol content in fuel.

2. Description of the Related Art

Near infrared (NIR) spectroscopy utilizes the near infra-red region of the electromagnetic spectrum (from 1100 nm to 2500 nm). A common source for NIR spectrum light is a diode laser. Common incandescent or quartz halogen light bulbs can also be used as broadband sources of NIR radiation. Typical applications include pharmaceutical, food and agrochemical quality control, as well as combustion research. Molecular overtone and combination vibrations are probed in NIR spectroscopy. Such transitions are quantum mechanically forbidden, leading to weak molar absorptions. This result in greater depth of penetration of NIR radiation compared to mid-infrared radiation. Near infrared spectroscopy is therefore not a particularly sensitive technique, but can be very useful in probing bulk material with little or no sample preparation. Because of the complexity of interpreting molecular overtone and combination absorption bands, multivariate wavelength calibration techniques are often employed to extract desired chemical information. Careful development of a set of calibration samples and application of multivariate calibration techniques is essential for NIR analytical methods.

NIR spectroscopy has rapidly developed into an important and extremely useful method of analysis. In fact, for certain research areas and applications, ranging from material science via chemistry to life sciences, it has become an indispensable tool, being fast and cost-effective while providing qualitative and quantitative information not available from other techniques.

NIR spectroscopy can rapidly and accurately measure the chemical and physical properties of a wide variety of materials. NIR has several advantages over alternative spectroscopic tools since the sample requires little, if any, preparation and the analysis can be performed rapidly at a very low cost.

### BRIEF SUMMARY OF THE INVENTION

A method for determining fuel quality comprises providing a mobile fuel analysis apparatus comprising a vehicle, a database comprising NIR spectra of standard fuel from a plurality of suppliers, and a near-infrared spectrometer, transporting the apparatus to a fuel distribution point, collecting fuel sample, and comparing a measured spectrum thereof to the near-infrared spectra in the database, and converting the data to corresponding quality parameters, wherein both the gasoline and diesel are measured by only one near-infrared spectrometer.

A detailed description is given in the following with reference to the accompanying drawings.

### BRIEF DESCRIPTION OF THE DRAWINGS

The invention can be more fully understood by reading the subsequent detailed description and examples with references made to the accompanying drawings, wherein:

FIG. 1a to FIG. 1h show comparison between quality parameters of gasoline fuel from a distribution point A measured in a conventional laboratory and by the method of the invention;

FIG. 2a to FIG. 2h show comparison between quality parameters of gasoline fuel from a distribution point B measured in a conventional laboratory and by the method of the invention;

FIG. 3a to FIG. 3d show comparison between quality parameters of diesel fuel from a distribution point A measured by analyzer in a conventional laboratory and by the method for determining oil quality of the invention;

FIG. 3e to FIG. 3h show comparison between quality parameters of diesel fuel from a distribution point B measured in a conventional laboratory and by the method of the invention;

FIG. 4a shows a mobile fuel analysis laboratory;

FIG. 4b shows a mobile fuel analysis apparatus;

FIG. 5a to FIG. 5h show quality parameters of gasoline fuel measured in a static state and in motion by the mobile fuel analysis apparatus of the invention; and

FIG. 6a to FIG. 6e show the quality parameters of diesel fuel measured in a static state and in motion by the mobile fuel analysis apparatus of the invention.

FIG. 7a to FIG. 7f show the ethanol content of gasoline fuel measured in a static state and in motion by the mobile fuel analysis apparatus of the invention.

### DETAILED DESCRIPTION OF INVENTION

The invention provides a mobile fuel analysis apparatus to directly measure the quality parameters of the fuel at a distribution point thereof.

Generally, a conventional fuel analysis laboratory comprises a plurality of analysis methods such as sulfur, density, flash point, distillation, cetane index, research octane number, benzene content, methylbenzene content, ethanol content, and oxygen content analysis. In order to make more analyses in a short time, the invention provides a method for determining fuel quality comprising collecting fuel and measuring near-infrared spectra thereof from wanted fuel distribution point and comparing the measured spectra to spectra of standard fuel in a database to obtain quality parameters of the collected fuel. The database comprises near-infrared spectra of standard fuel from a plurality of suppliers to establish correlation between fuel quality parameters and spectra of fuel.

Construction of the database comprises collecting fuel from 6% to 12% of gasoline stations in one country, using Taiwan as an example. The collected fuel are analyzed by a plurality of analysis methods in a conventional laboratory to obtain quality parameters thereof and scanned by a near-infrared spectrometer to obtain spectra thereof. The quality parameters of the collected fuel and corresponding spectra thereof are input into the near-infrared spectrometer to establish the database of the invention.

The collected fuel is scanned again by the near-infrared spectrometer to obtain the fuel-sensitive wavelength range of near-infrared. The fuel-sensitive wavelength range of near-infrared is between 700 nm and 2500 nm. For gasoline, the fuel-sensitive wavelength range is preferably between 1100 nm and 1670 nm or 1790 nm and 2100 nm. For diesel, the oil-sensitive wavelength range is preferably between 1100 nm and 1670 nm or 1825 nm and 2200 nm. With the database and preferred fuel-sensitive wavelength range, quality parameters of unknown fuels can be obtained by comparing the spectra thereof to spectra of the standard fuels in the database. In addition, both the gasoline and diesel are measured by only one near-infrared spectrometer.

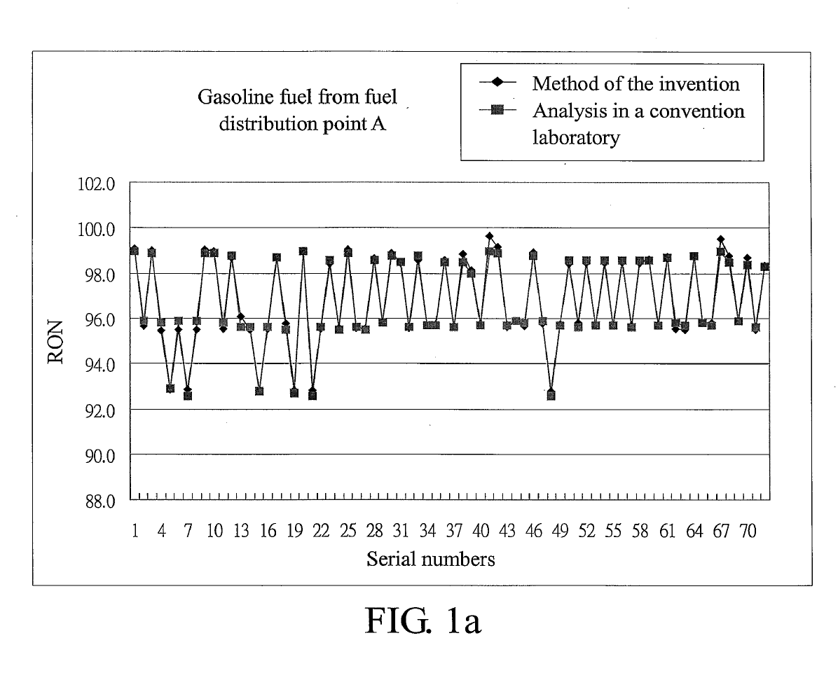

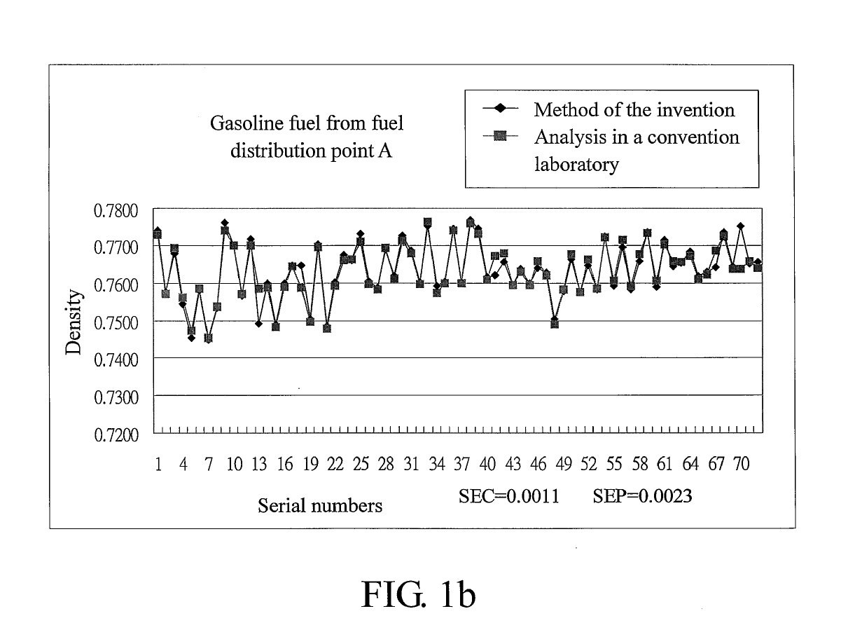

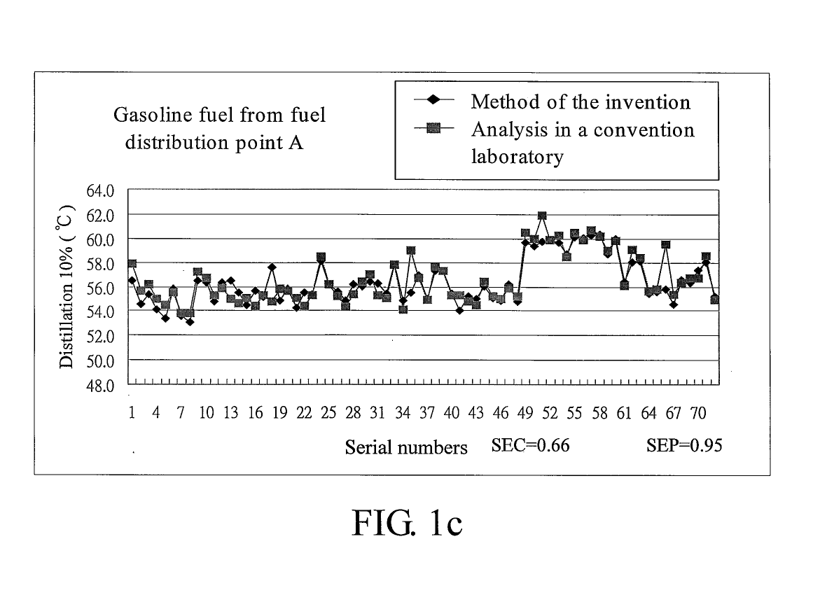

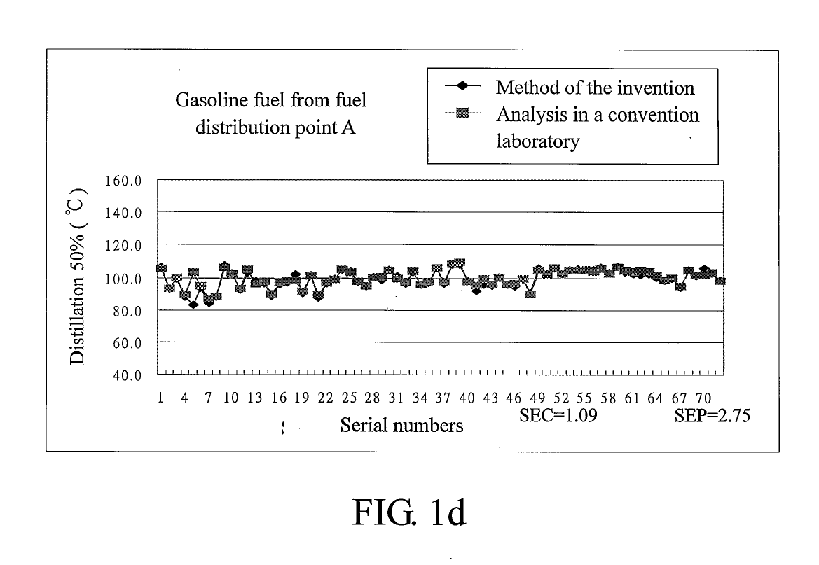

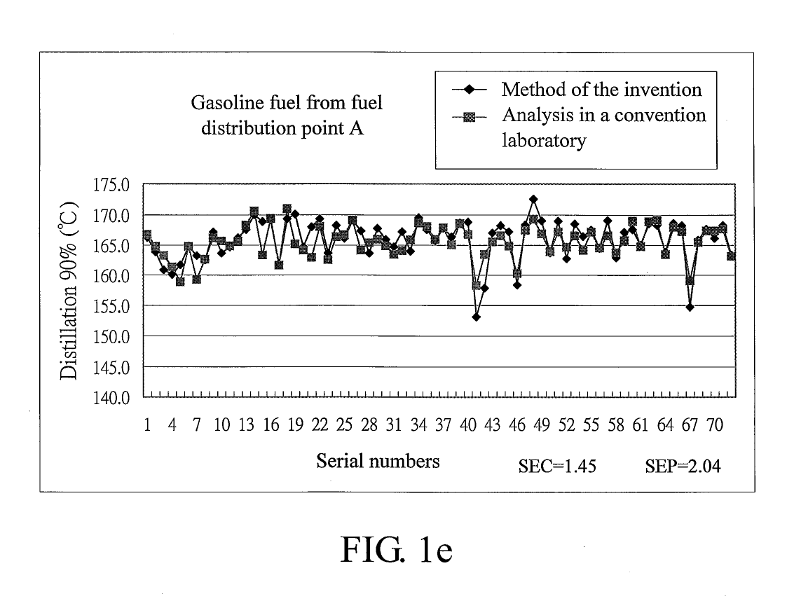

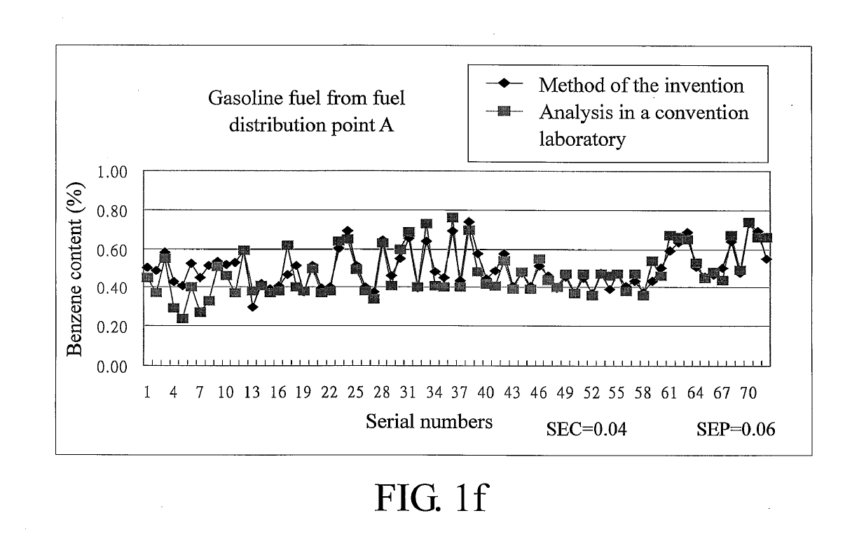

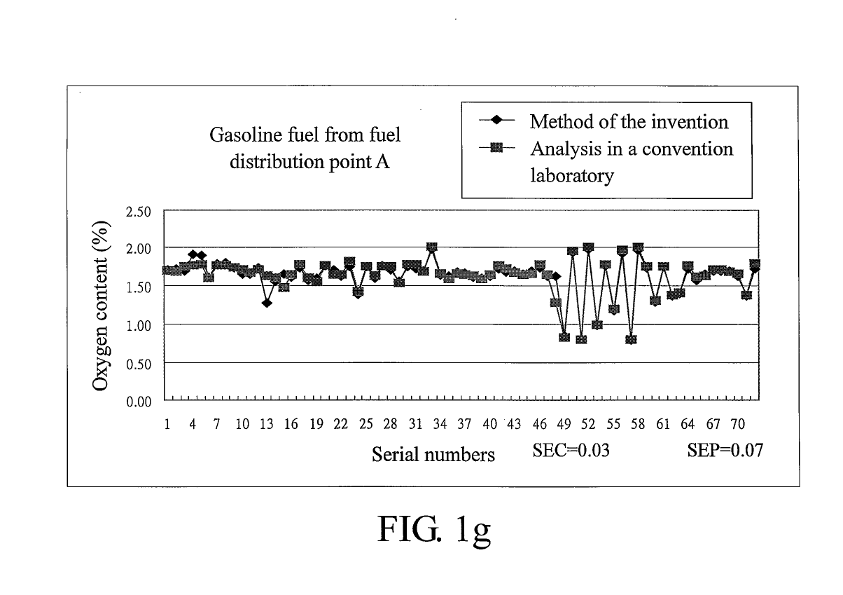

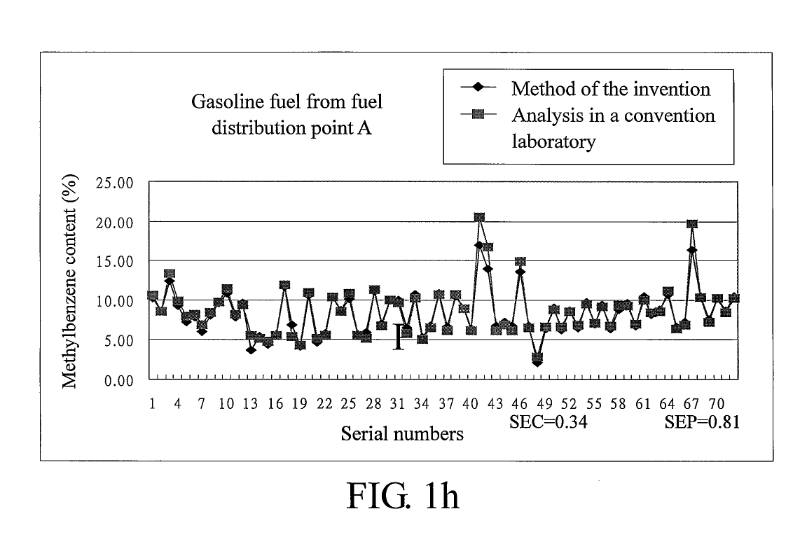

FIG. 1a to FIG. 1h show comparison between quality parameters, such as research octane number, density, temperature of distillation 10%, temperature of distillation 50%, temperature of distillation 90%, benzene content, oxygen content and methylbenzene content of gasoline fuel from a distribution point A, measured by analysis in a conventional laboratory and by the method of the invention. In FIG. 1a to FIG. 1h, the x-coordinate represents serial numbers of gasoline fuel from a distribution point A and y-coordinate represents quality parameters thereof. In addition, SEC represents the deviation of transforming quality parameter of fuels, measured in a conventional laboratory, into near-infrared spectrum. SEP represents the deviation between quality parameters of fuels measured in a conventional laboratory and obtained by comparing the spectra thereof, obtained by a near-infrared spectrometer, to the spectra in the database.

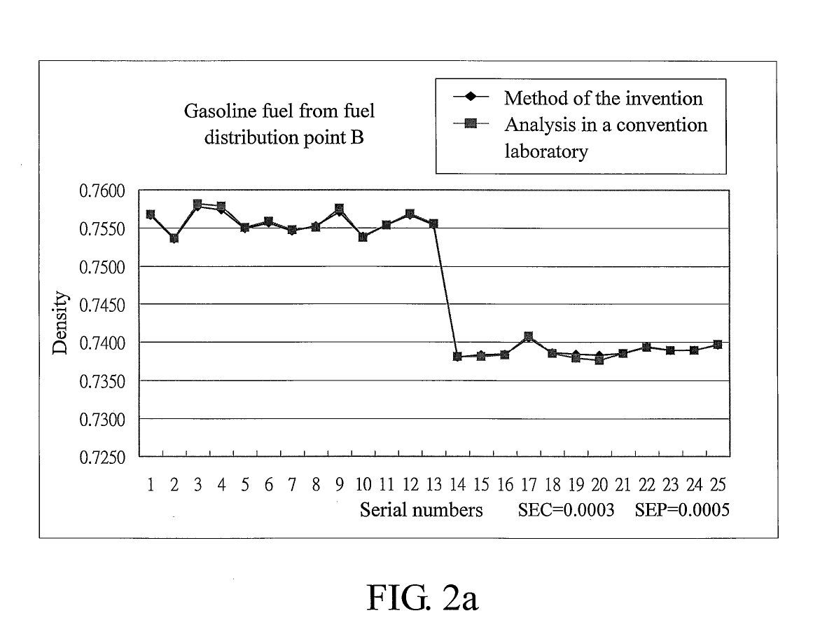

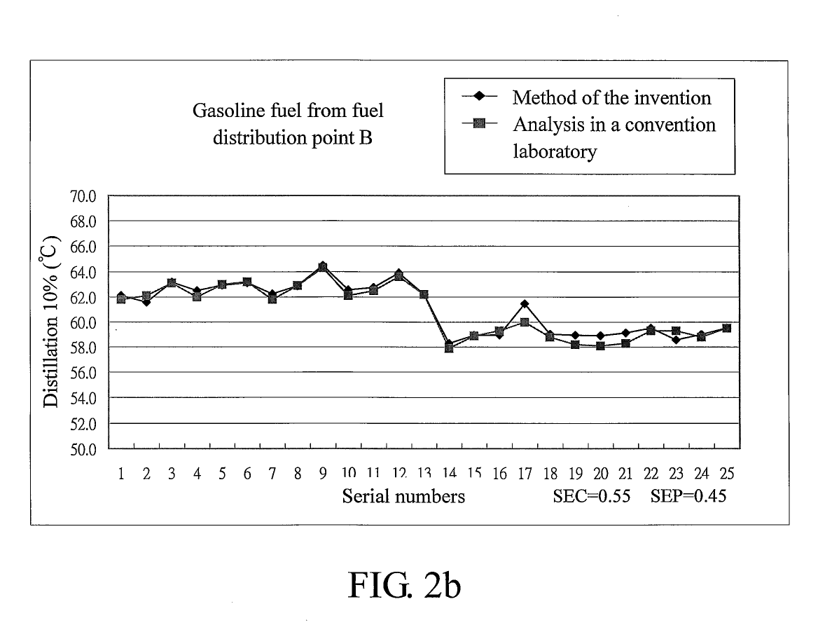

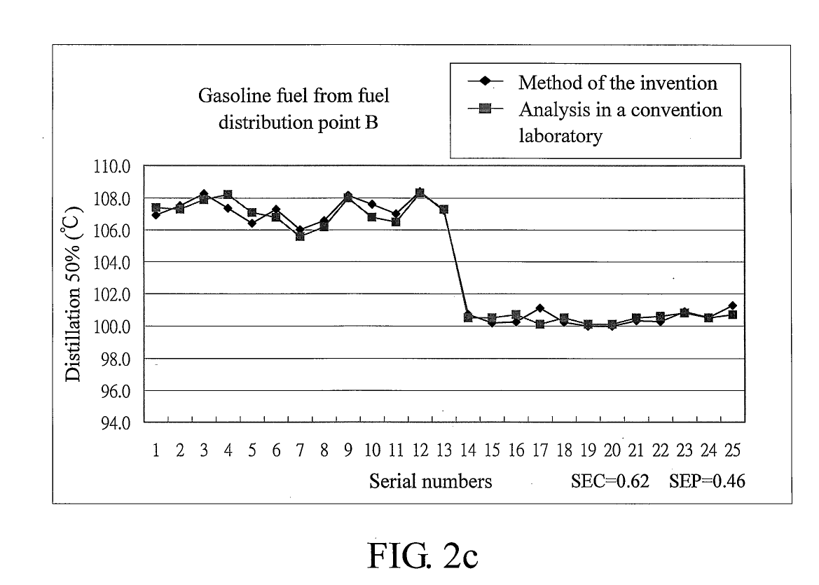

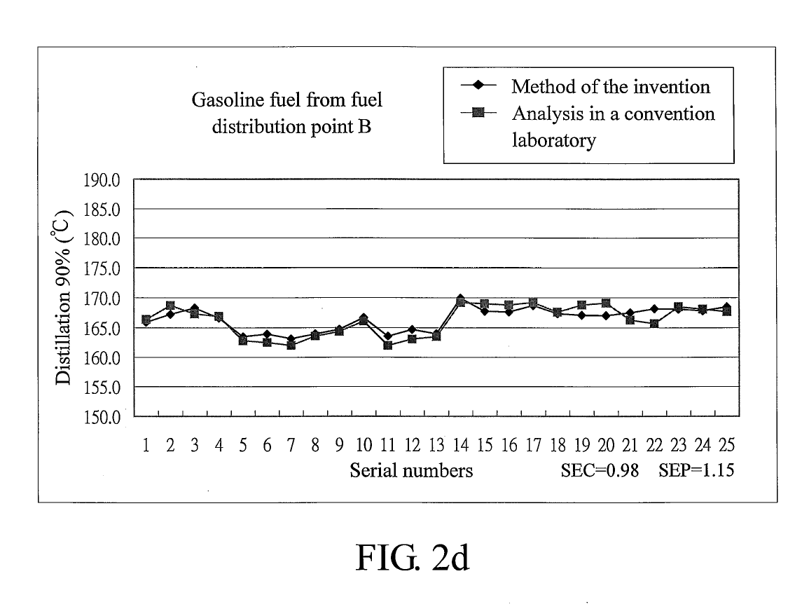

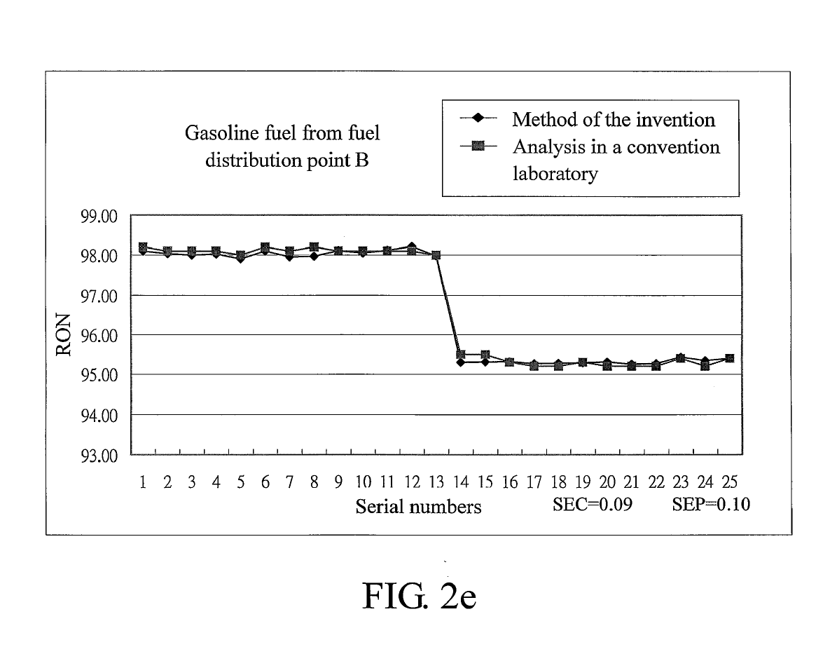

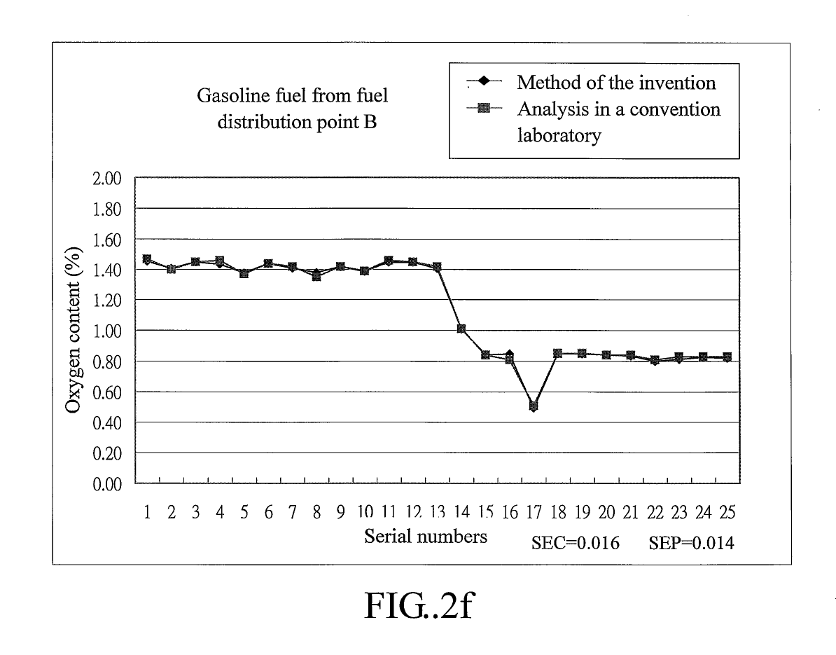

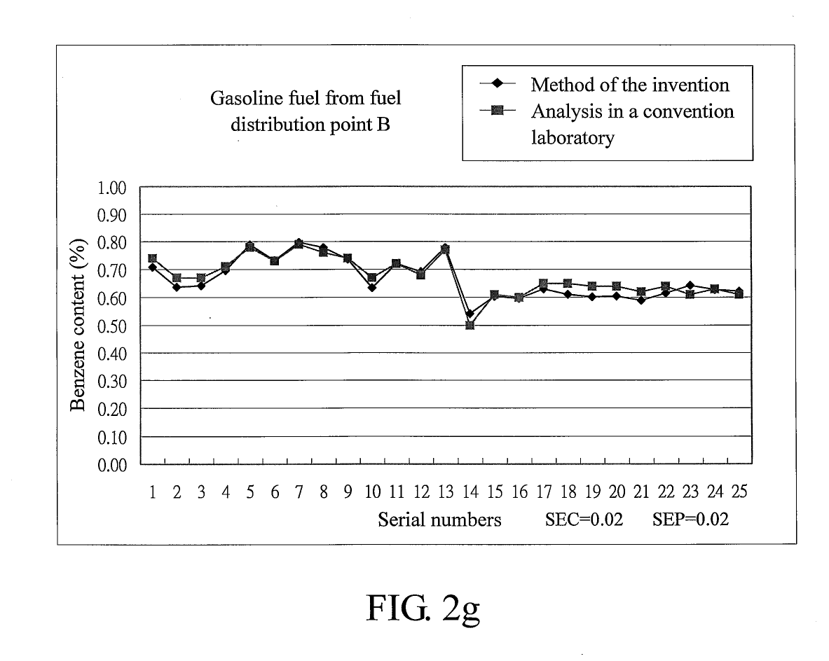

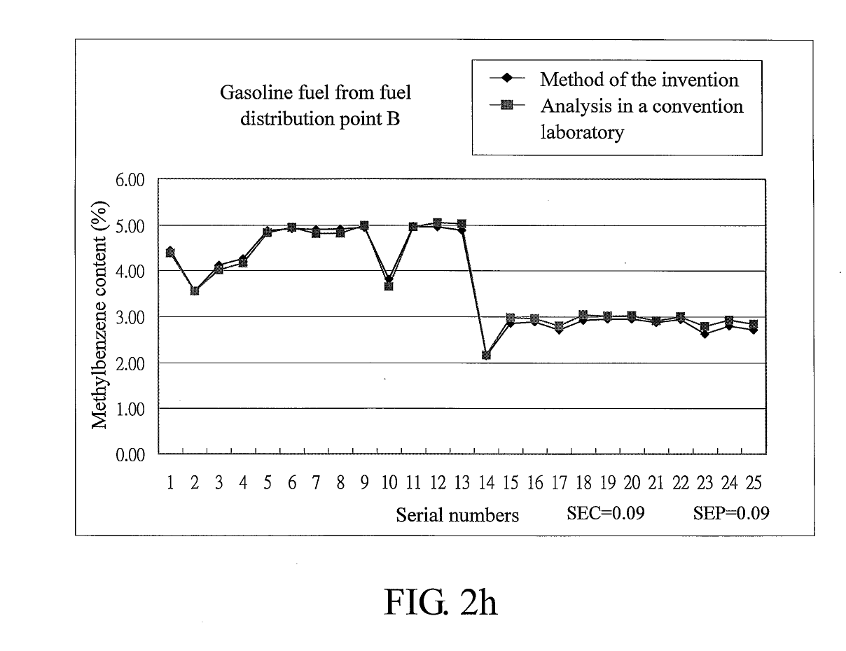

As shown in FIG. 1a to FIG. 1h, the quality parameters of gasoline fuel from the distribution point A obtained by comparing spectra thereof to the spectra of standard fuels in the database are substantially identical to those measured in a conventional laboratory. FIG. 2a to FIG. 2h shows comparison between quality parameters, such as research octane number (RON), density, temperature of 10% distillation, temperature of 50% distillation, temperature of 90% distillation, benzene content, oxygen content and methylbenzene content of gasoline from a distribution point B, measured in a conventional laboratory and by the method of the invention. As shown in FIG. 2a to FIG. 2h, the quality parameters of gasoline fuel from a distribution point B obtained by comparing the spectra thereof to the spectra of the standard fuels in the database are substantially identical to those measured in a conventional laboratory.

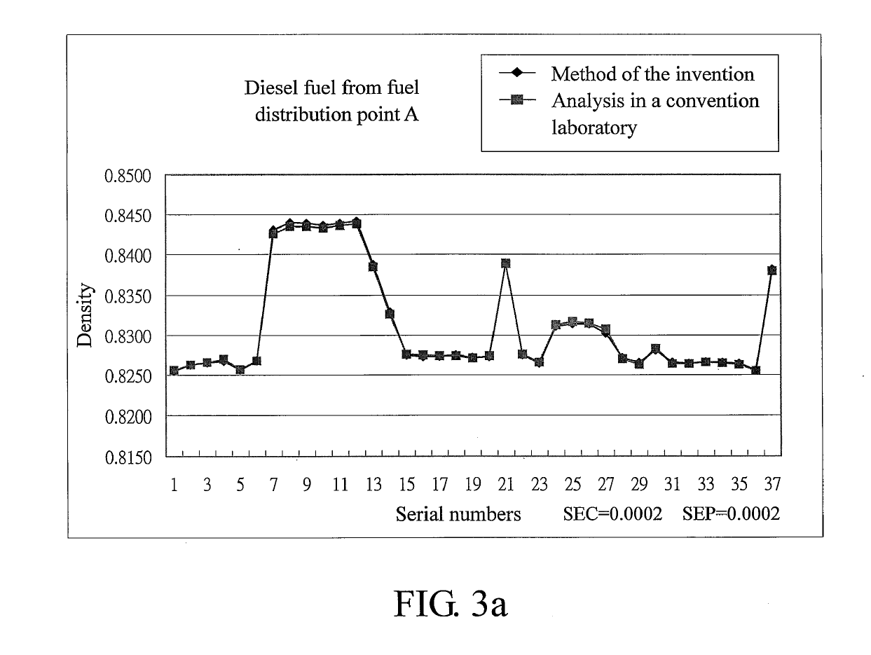

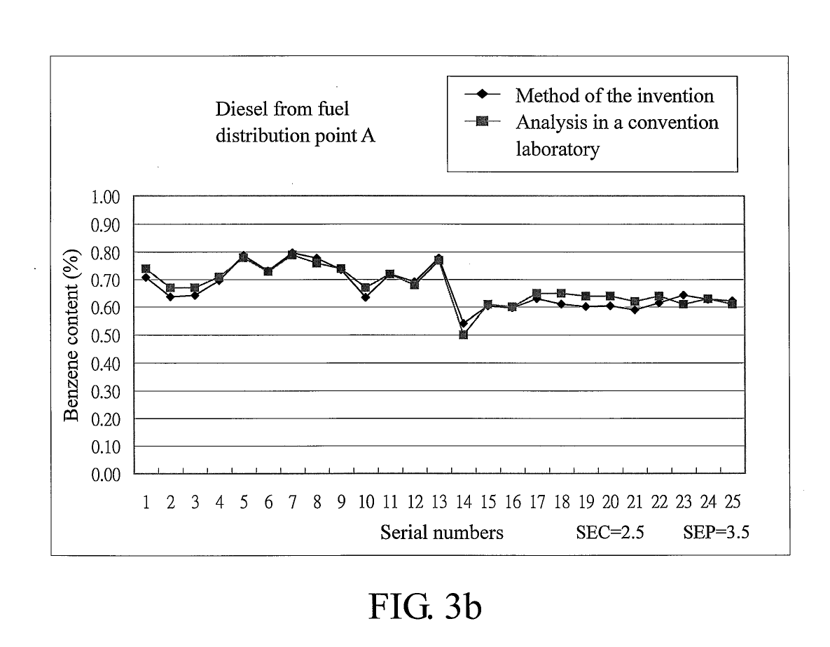

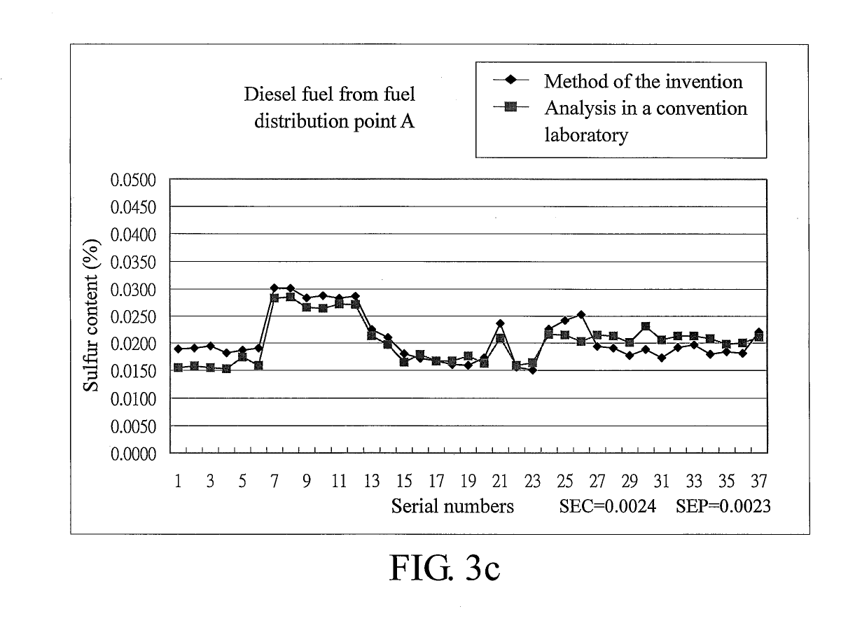

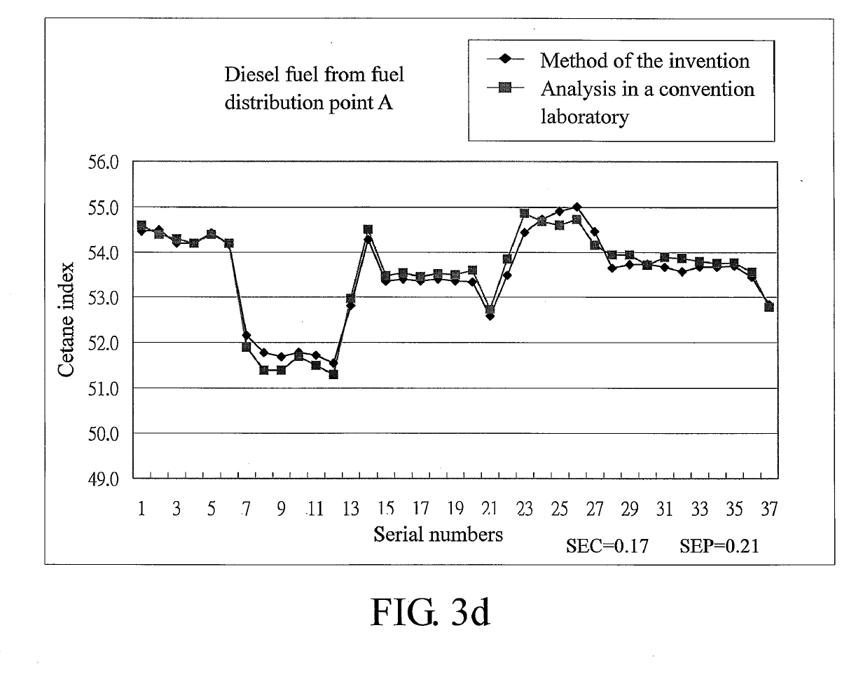

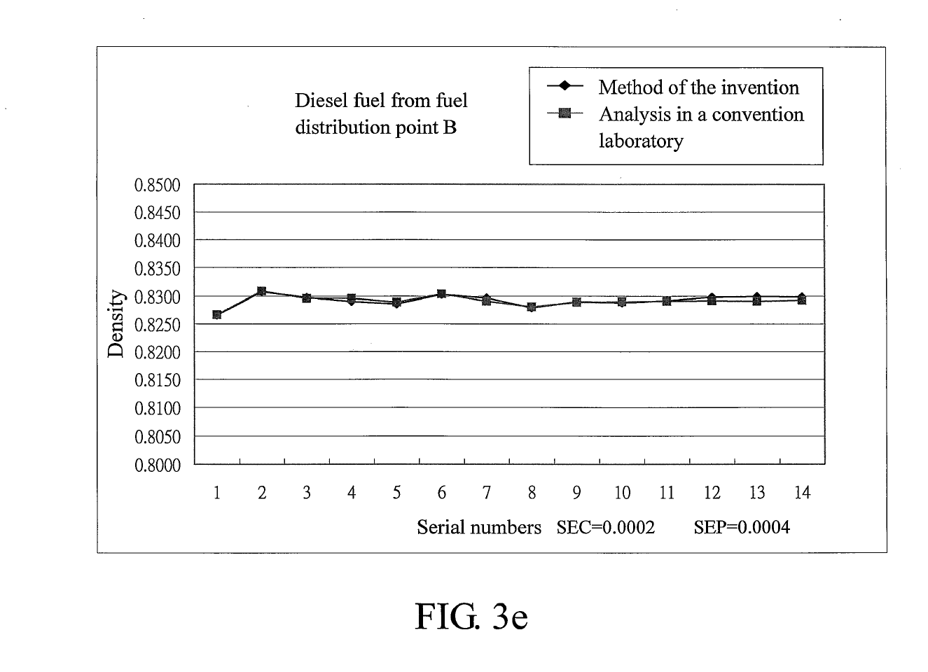

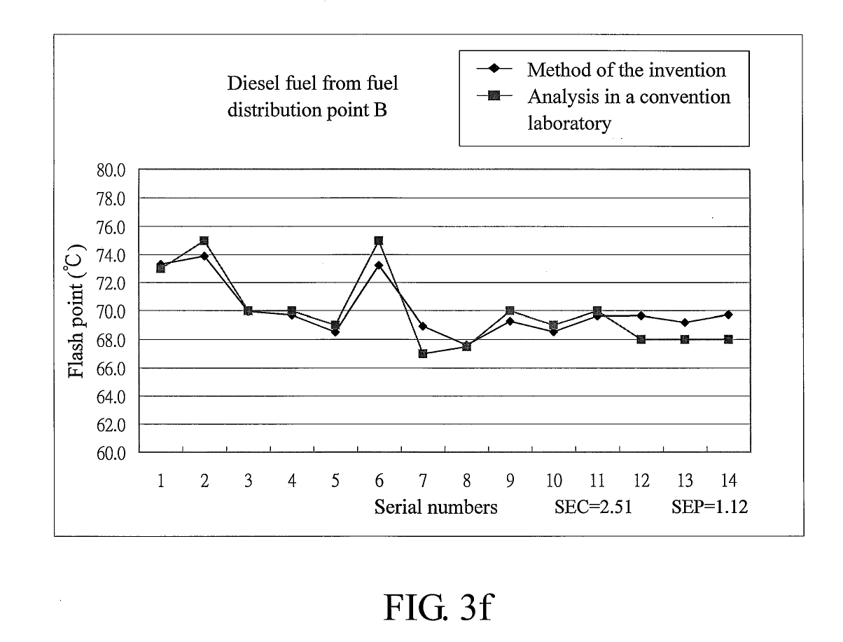

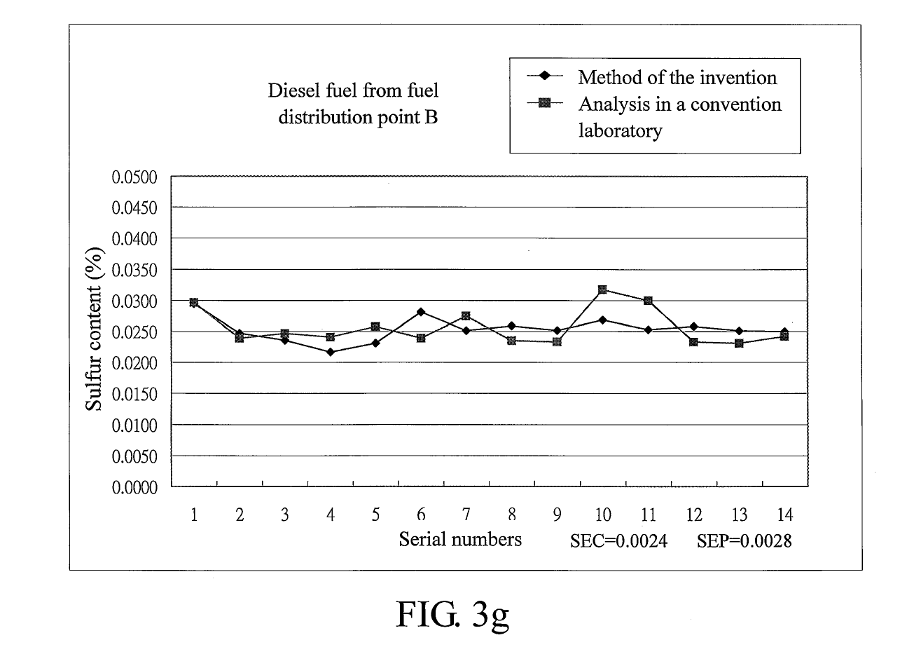

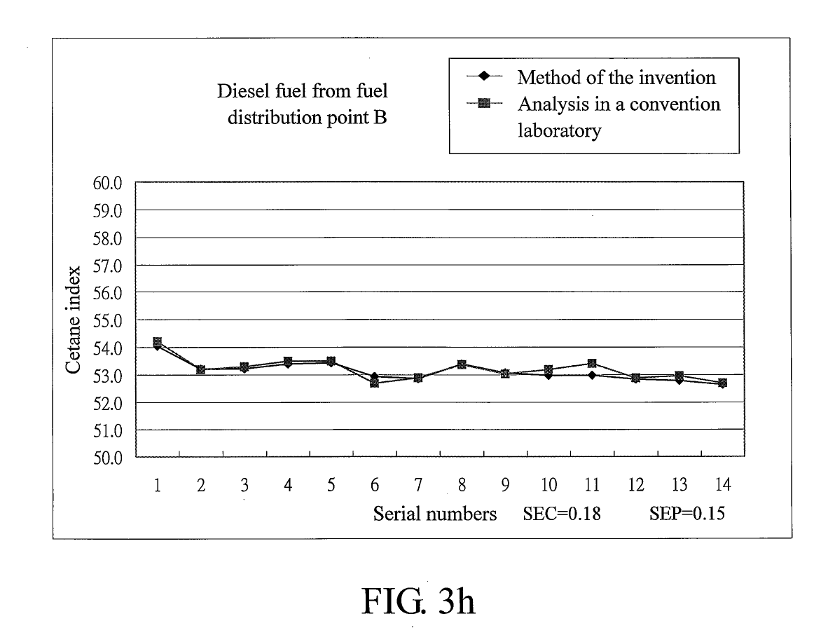

FIG. 3a to FIG. 3d show the comparison between quality parameters such as density, flash point, sulfur content and cetane index of diesel fuel from the distribution point A measured in a conventional laboratory and by the method of the invention. FIG. 3e to FIG. 3h show comparison between quality parameters such as density, flash point, sulfur content and cetane index of diesel from the distribution point B measured in a conventional laboratory and by the method of the invention. The near-infrared wavelength for scanning the diesel is preferably between 1100 nm and 1670 nm or between 1825 nm and 2200 nm. As shown in FIG. 3a to FIG. 3h, quality parameters of diesel fuel measured by the method of the invention are substantially identical to those measured in a conventional laboratory. According to FIG. 1a to FIG. 3h, quality parameters of gasoline fuel and diesel fuel measured by the method of the invention are accurate.

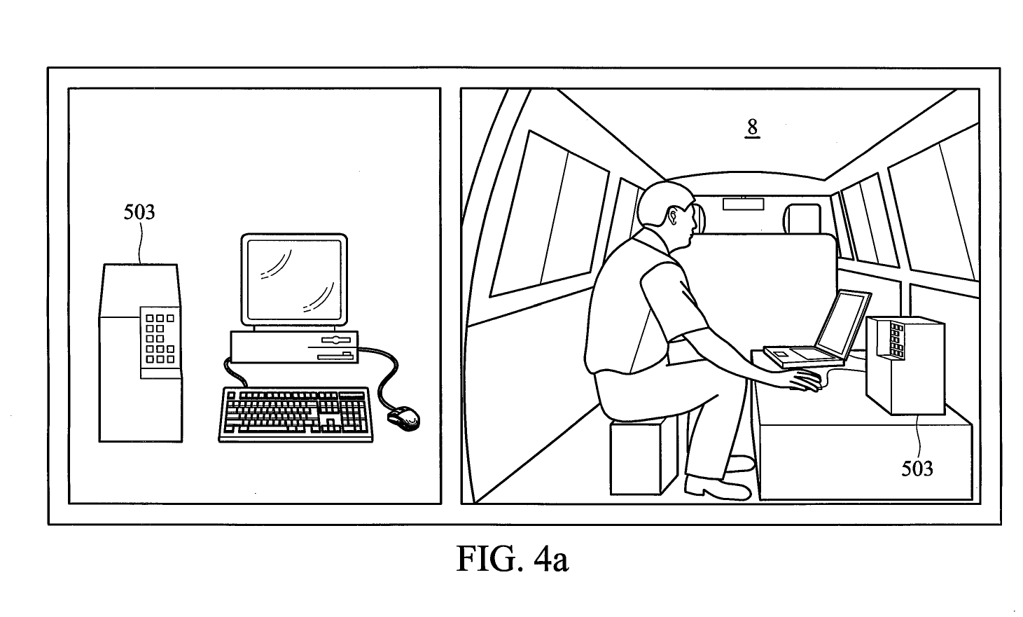

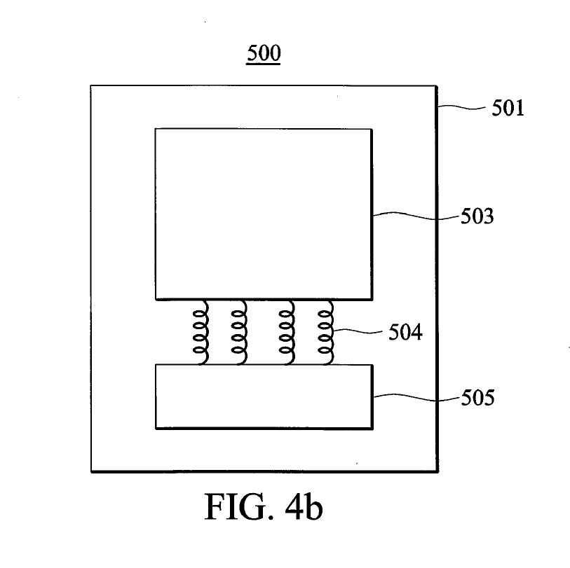

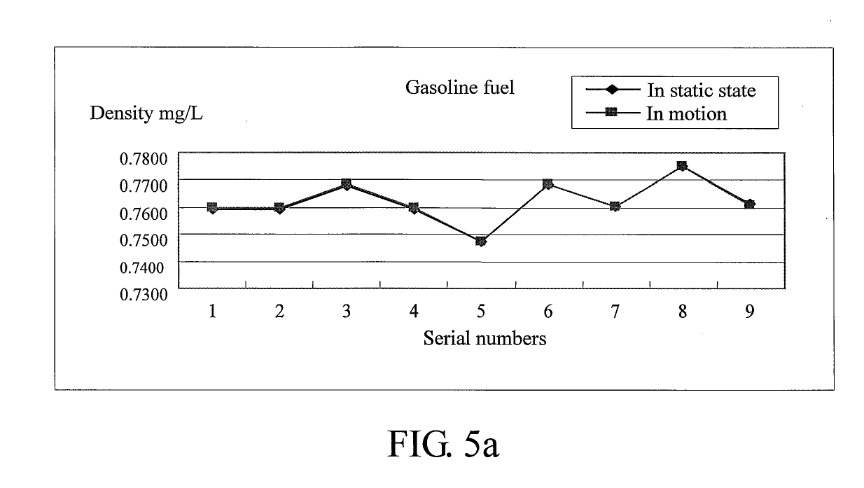

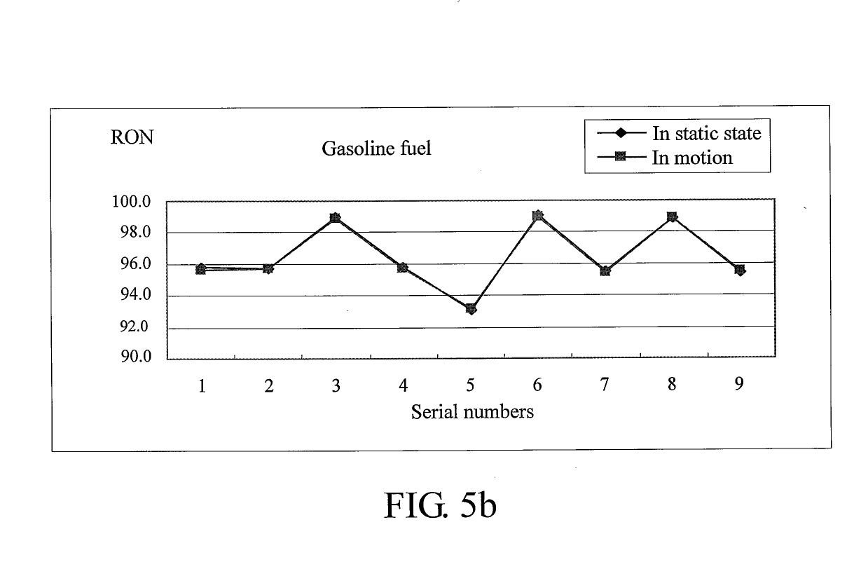

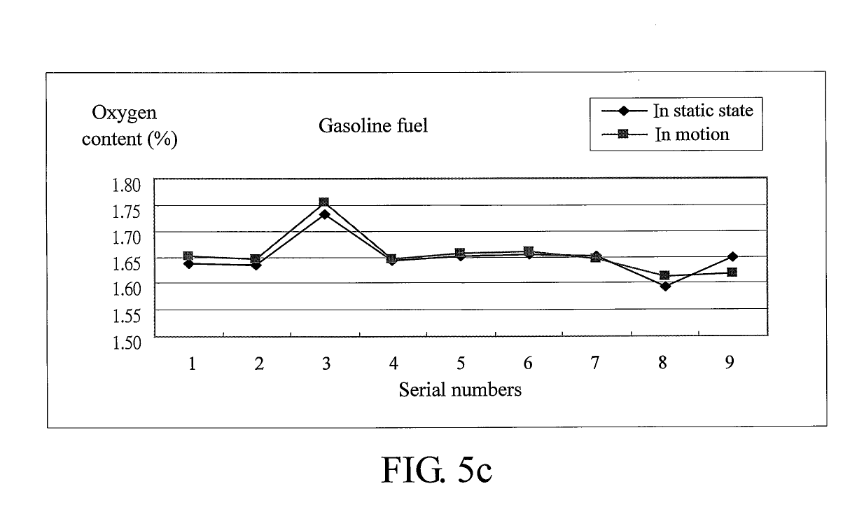

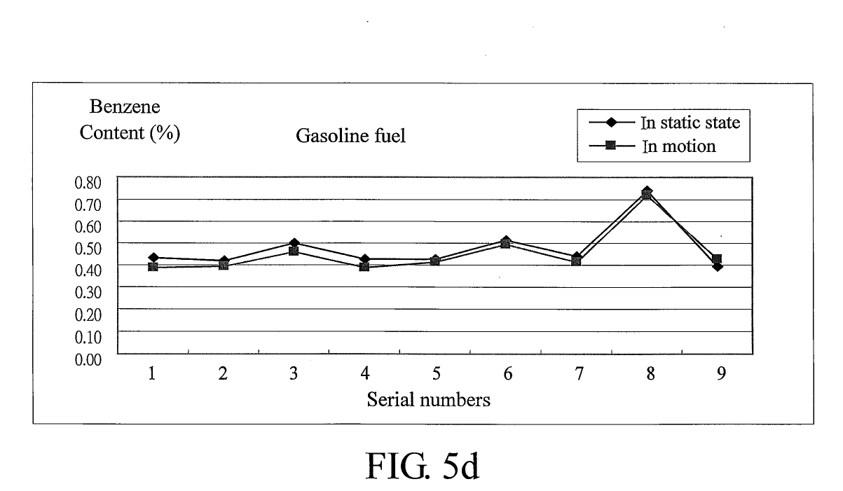

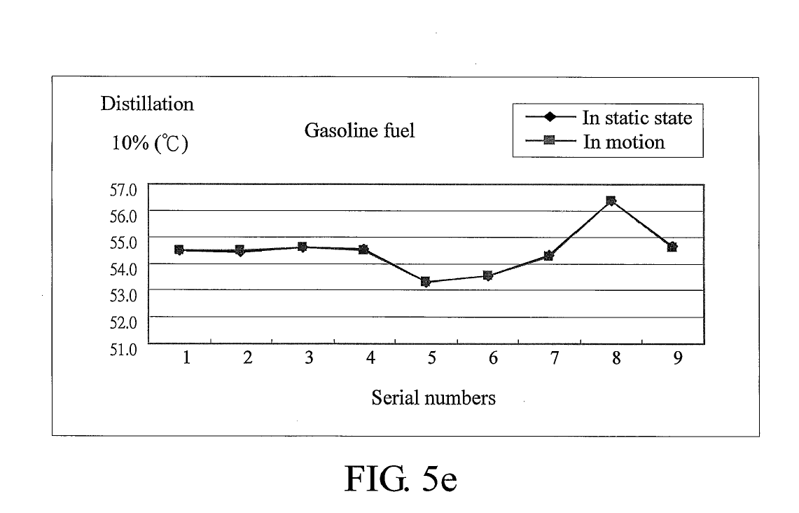

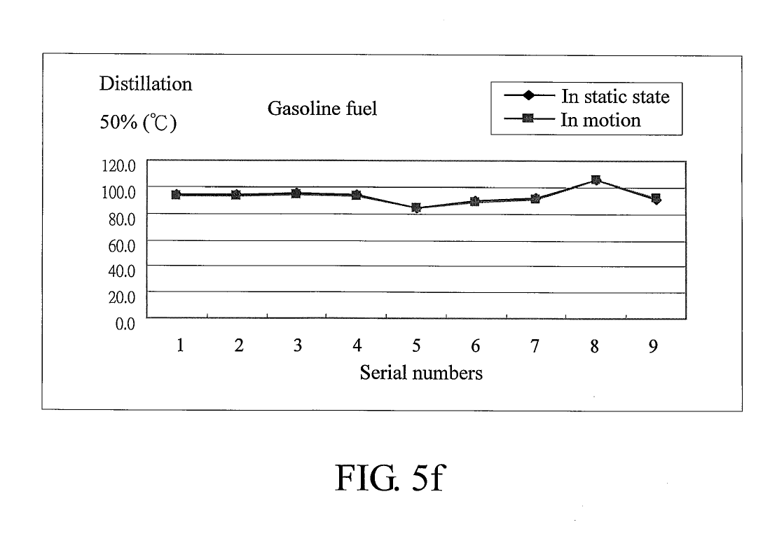

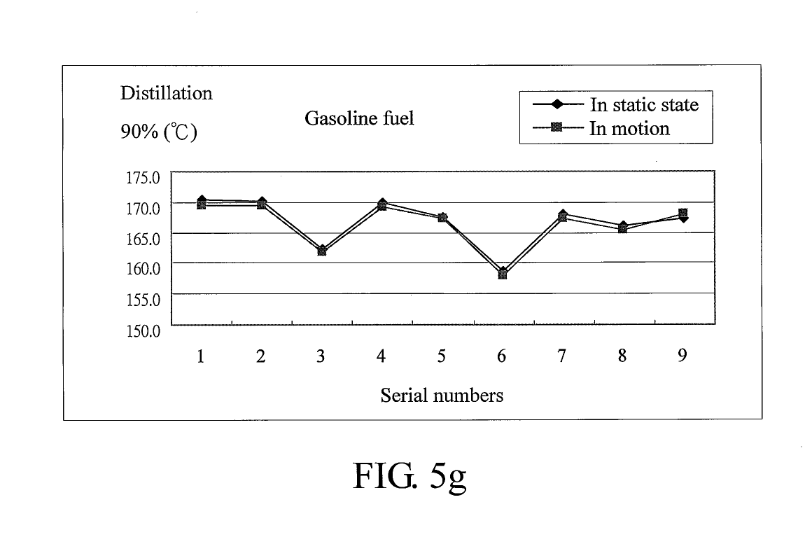

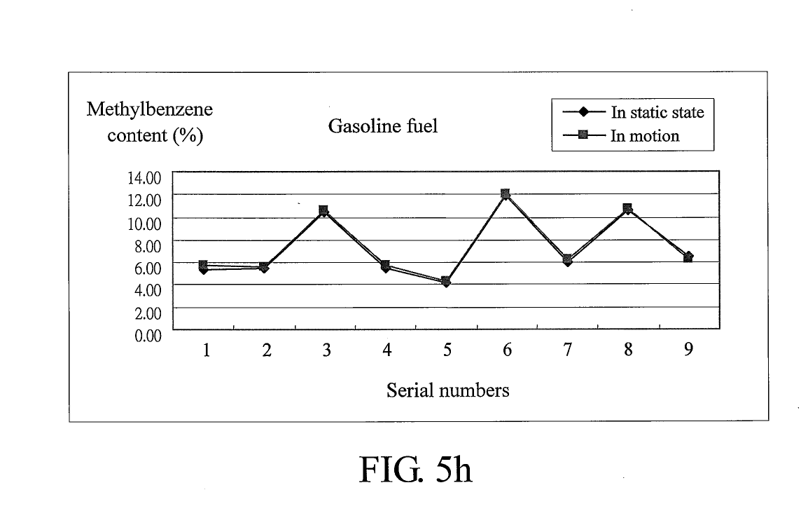

In another aspect, the invention provides a mobile fuel analysis apparatus as shown in FIG. 4a. FIG. 4b shows a mobile fuel analysis apparatus 500 comprising a vehicle 501 and a near-infrared spectrometer 503 thereon. The mobile fuel analysis apparatus 500 can move to a predetermined fuel distribution point to collect fuels and measure spectra thereof, and quality parameters of the collected fuels can be obtained by comparing the measured spectra to the near-infrared spectra of the standard fuels in the database of the invention, avoiding the need to transport samples to a conventional laboratory. The method for determining the fuel quality of the invention reduces analysis cost, and achieves more analyses in a short time. The vehicle 501 of the mobile fuel analysis apparatus 500 may be any kind of transportation such as car, truck or preferably van 8. The near-infrared spectrometer 503 may be equipped on the backseat of the vehicle 501. The method for determining the fuel quality of the invention can analyze the collected oil sample when the vehicle is moving. In order to reduce the deviation of analyses caused by vibration of the vehicle 501 in motion, the near-infrared spectrometer 503 may be equipped on a shockproof device 505 as shown in FIG. 5b. The shockproof device 505 comprises a base and a plurality of shock absorbers 504 disposed under the base.

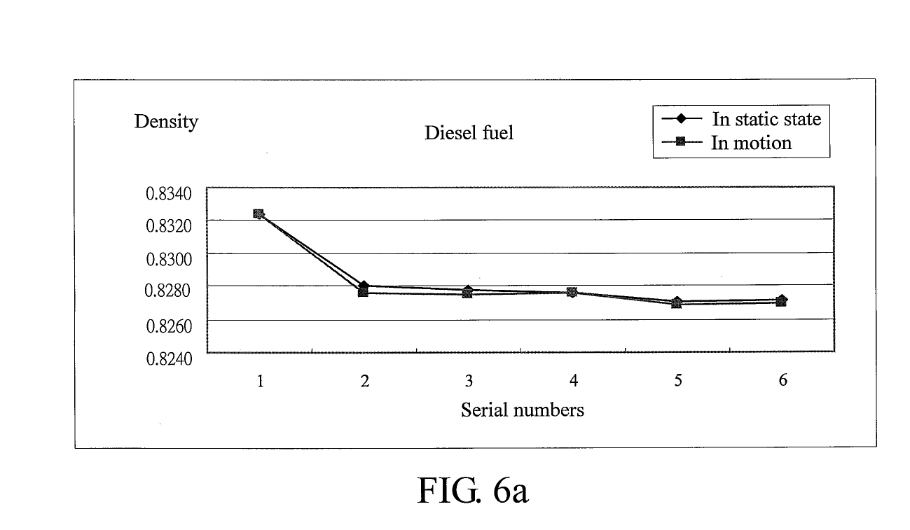

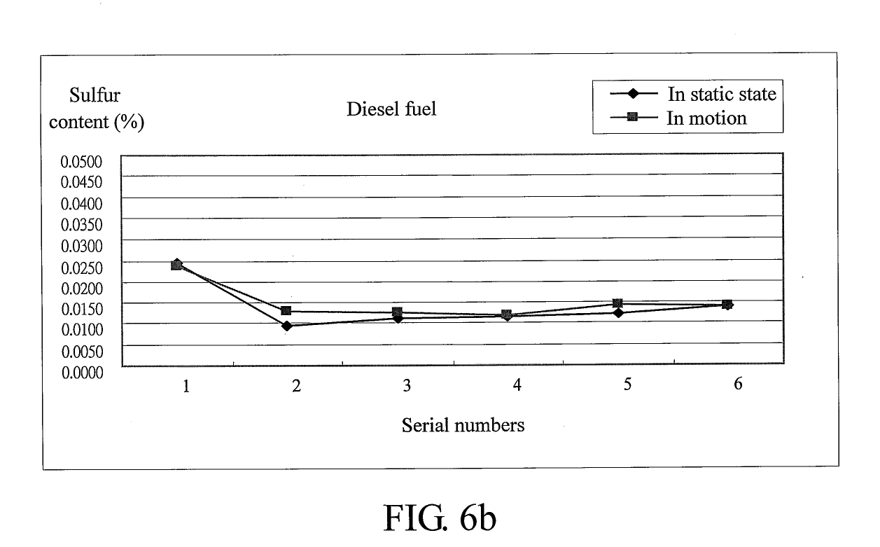

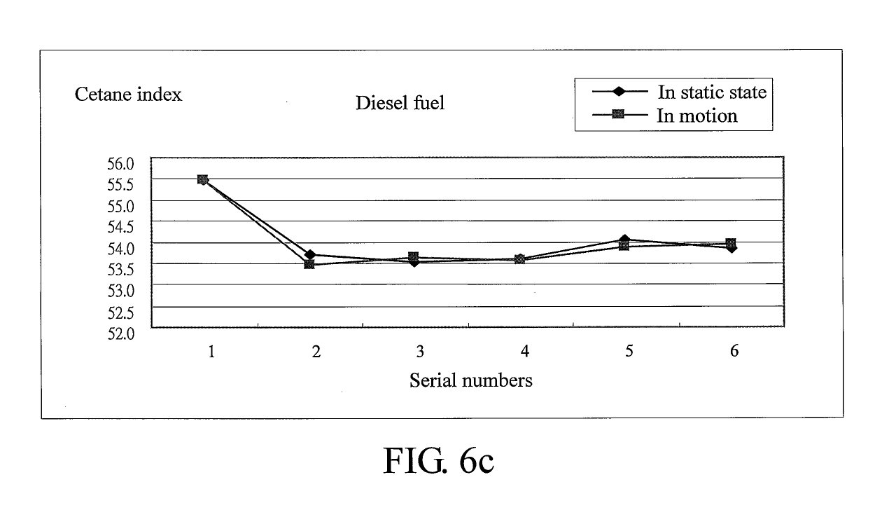

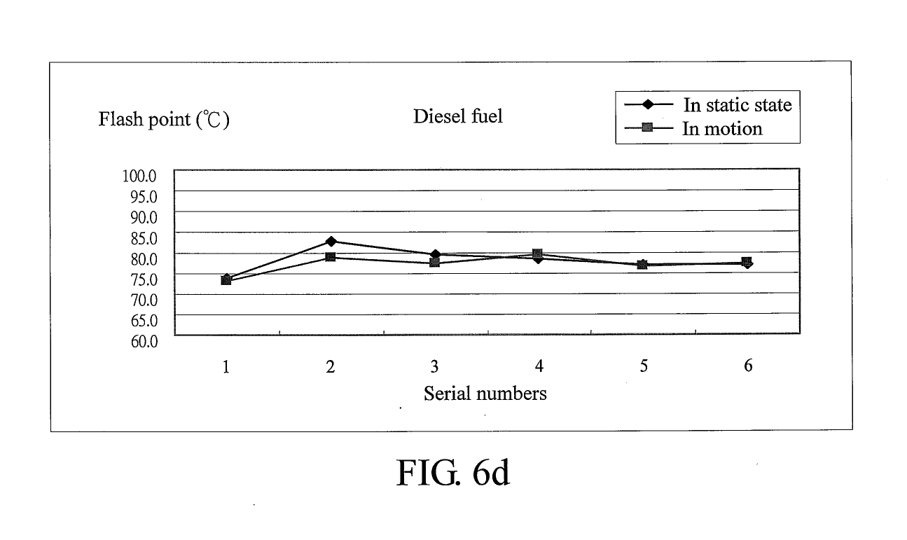

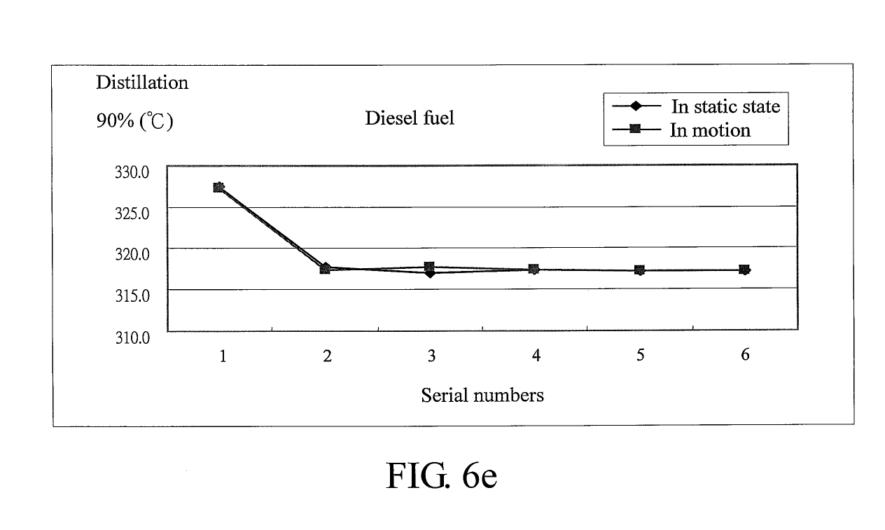

FIG. 5a to FIG. 5h show quality parameters of gasoline fuel, such as density, research octane number, oxygen content, temperature of distillation 10%, temperature of distillation 50%, temperature of distillation 90% and methylbenzene content, measured in a static state and in motion by the mobile fuel analysis apparatus of the invention. FIG. 6a to FIG. 6e show quality parameters of diesel fuel, such as density, flash point, sulfur content and cetane index, temperature of distillation 90%, measured in a static state and in motion by the mobile fuel analysis apparatus of the invention. As shown in FIG. 5a to FIG. 6e, the quality parameters measured at a velocity less than 60 km/h or with a jolt are identical to those measured in a static state. Accordingly, the mobile fuel analysis apparatus of the invention measures the quality parameter of fuels accurately with the shockproof device in motion.

In another embodiment, the invention further provides a method for determining ethanol fuel or ethanol content in gasoline or diesel fuel. There are some differences between the chemical characteristic of ethanol fuel and fossil fuel. For example, ethanol does not only corrode metal (e.g. copper or zinc), but also causes piping materials to swell, soften, and age, and also increases the vapor pressure of fuel to slow down engine acceleration. In addition, ethanol can easily absorb moisture resulting in the corrosion of the gasoline tank.

In order to predict ethanol content of fuel, an ethanol database was constructed. Firstly, 60 gasoline samples from 1.0% to 15.0% of ethanol in Taiwan were collected. The gasoline samples were collected form two gasoline manufacturing companies including Chinese petroleum corporation (CPC) and Formosa petroleum corporation (FPC). Next, all collected gasoline samples were analyzed by a standard method (ASTM D-4815 method) to construct a database and set up NIR predication calibrations by statistical analysis of MDPCS and PLS. In this embodiment, three calibrations were set up. The calibrations included NIR calibration C, F, and C+F, wherein the NIR calibration C, F, and C+F were set up by using the CPC gasoline, the FPC gasoline, and all gasoline samples, respectively.

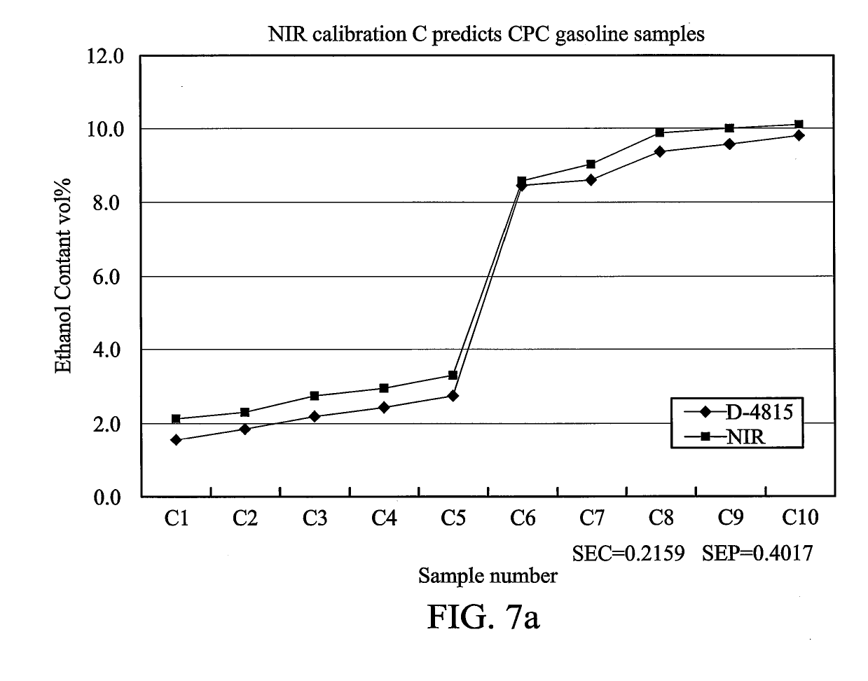

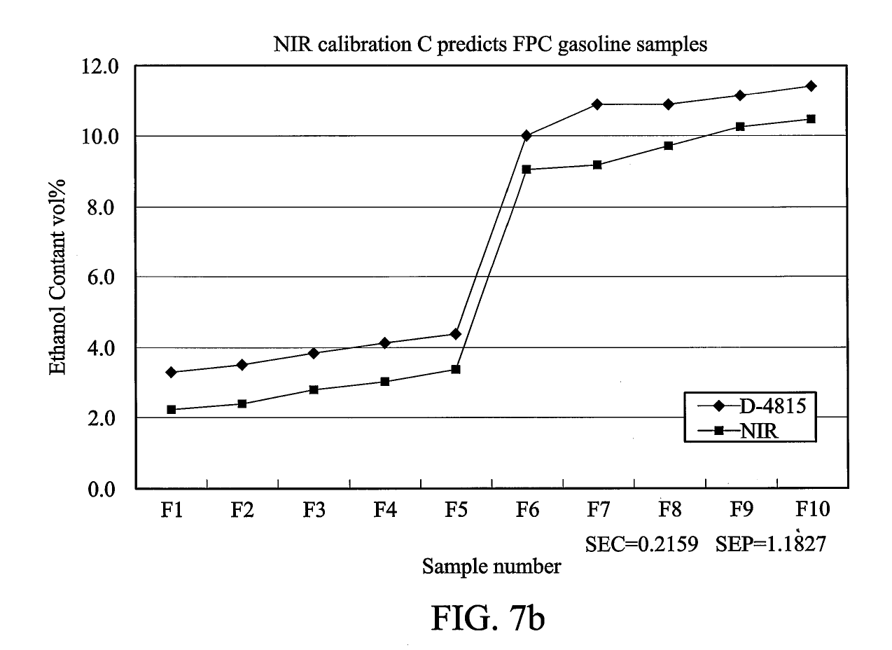

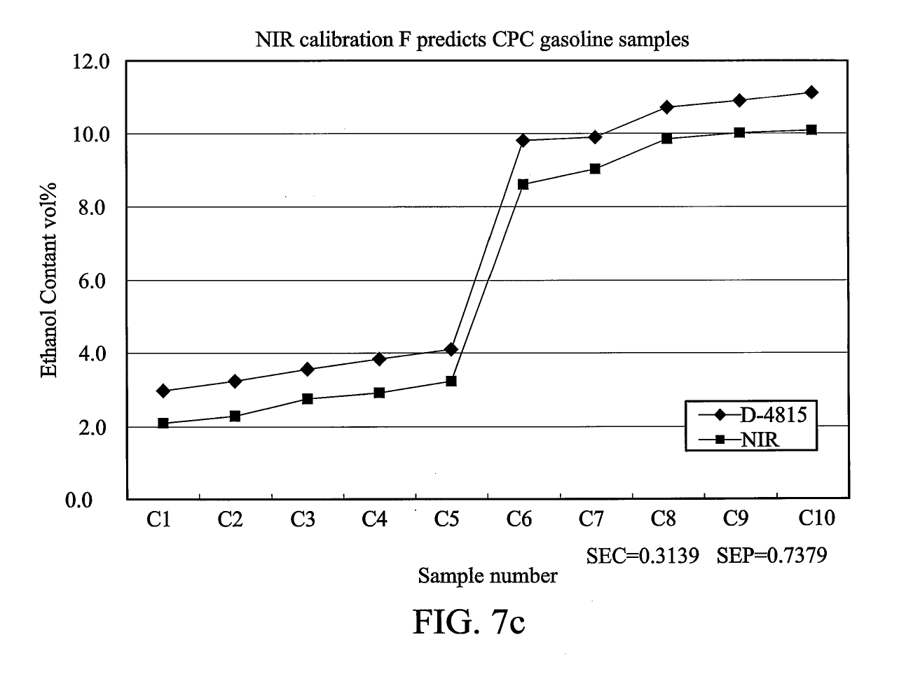

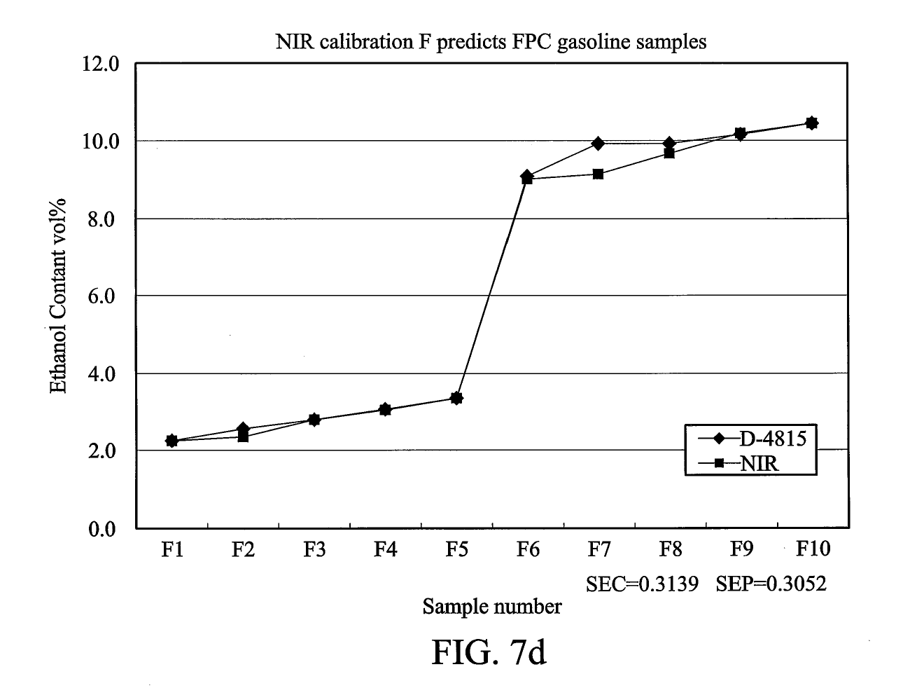

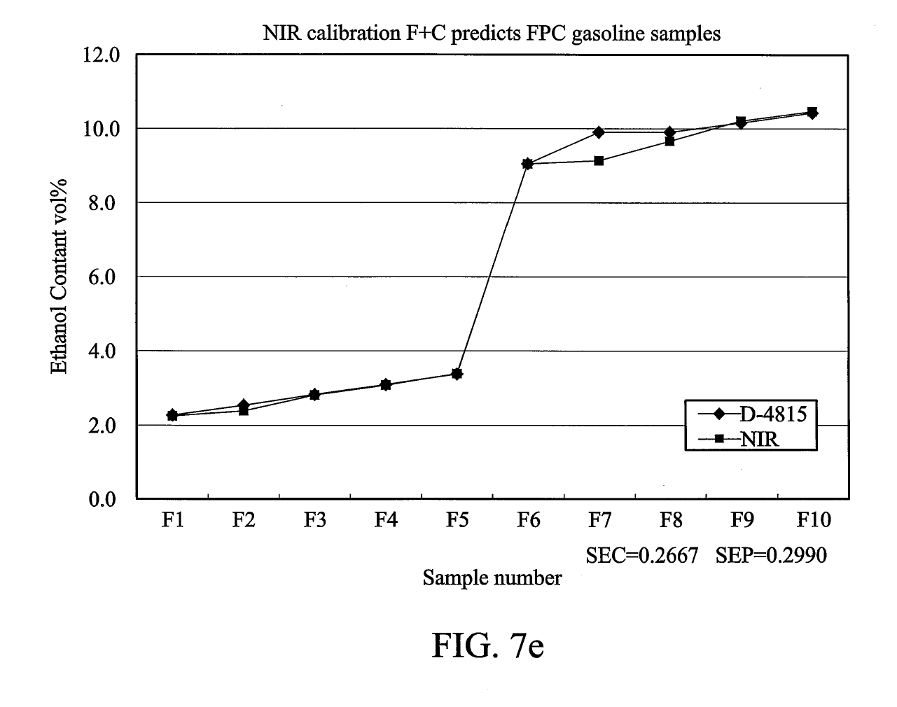

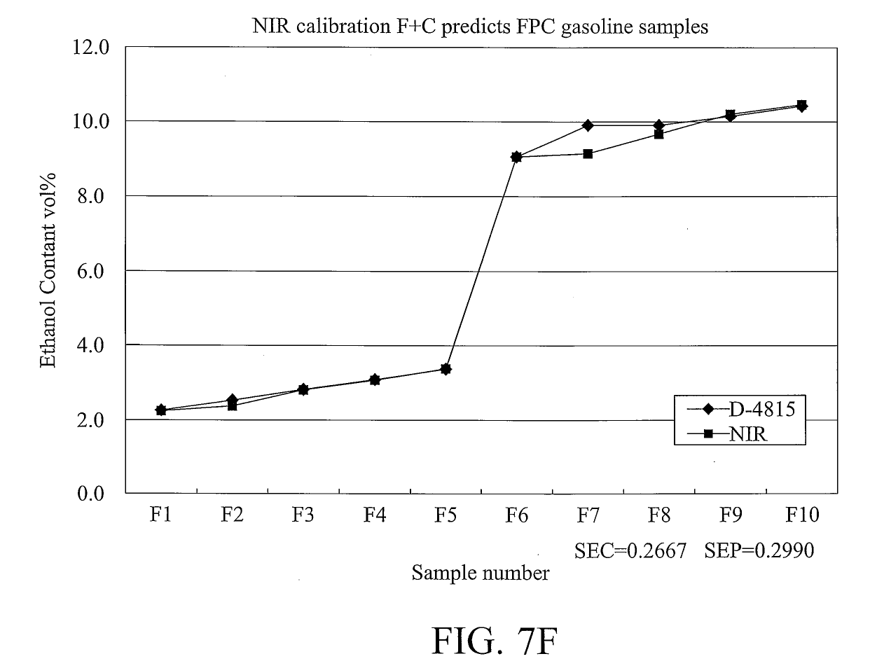

FIG. 7a to FIG. 7f show the ethanol content of gasoline fuel measured in a static state by the mobile fuel analysis apparatus of the invention, wherein FIGS. 7a-7b show using NIR calibration C to predict ethanol content, FIGS. 7c-7d show using NIR calibration F to predict ethanol content, and FIGS. 8e-8f show using NIR calibration C+F to predict ethanol content. As shown in FIGS. 7a-7f, using the NIR calibration C+F can obtain an accurate result as compared with only using the NIR calibration C or F. Accordingly, the method of the invention accurately predicted the ethanol content of the gasoline samples.

Finally, while the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for determining fuel quality comprising:
(a) providing a mobile fuel analysis apparatus comprising:
a vehicle;
a database comprising near-infrared spectra of standard fuel from a plurality of suppliers; and
a near-infrared spectrometer equipped on the vehicle;
(b) moving the near-infrared spectrometer to a fuel distribution point by the vehicle;
(c) collecting a near-infrared spectrum of an fuel sample from the fuel distribution point, wherein the fuel sample comprises gasoline and diesel; and
(d) comparing the collected spectra to the near-infrared spectra in the database, and converting the collected spectra into corresponding quality parameters, wherein the database comprises near-infrared spectra converted from quality parameters of the standard fuels selected from the group consisting of sulfur, density, flash point, distillation, cetane index, research octane number, benzene, methylbenzene, and ethanol content, and dissolved oxygen is measured by respective analysis methods, and both the gasoline and diesel are measured by only one near-infrared spectrometer.

2. The method for determining fuel quality as claimed in claim 1, wherein the near-infrared spectrum of the fuel sample is collected when the vehicle is in a static state.

3. The method for determining fuel quality as claimed in claim 1, wherein the near-infrared spectrum of the fuel sample is collected when the vehicle is moving.

4. The method for determining fuel quality as claimed in claim 1, wherein the wavelength of the near-infrared for collecting the spectrum of the oil sample is between 600 nm and 2600 nm.

5. The method for determining fuel quality as claimed in claim 1, wherein the fuel sample is gasoline fuel and the wavelength of the near-infrared for collecting the spectrum thereof is between 1100 nm and 1670 nm.

6. The method for determining fuel quality as claimed in claim 1, wherein the fuel sample is gasoline fuel and the wavelength of the near-infrared for collecting the spectrum thereof is between 1790 nm and 2100 nm.

7. The method for determining fuel quality as claimed in claim 1, wherein the fuel sample is diesel fuel and the wavelength of the near-infrared for collecting the spectrum thereof is between 1100 nm and 1670 nm.

8. The method for determining fuel quality as claimed in claim 1, wherein the fuel sample is diesel fuel and the wavelength of the near-infrared for collecting the spectrum thereof is between 1825 nm and 2200 nm.

9. The method for determining fuel quality as claimed in claim 1, wherein the wavelength of the near-infrared for collecting the spectrum thereof is between 600 nm and 700 nm.

10. The method for determining fuel quality as claimed in claim 1, wherein the step (d) takes about 5 minutes.

11. The method for determining fuel quality as claimed in claim 1, further comprises repeating steps (b) to (d) to determine fuel quality of a plurality of fuel distribution points.

12. A method for determining ethanol content in fuel comprising
(a) providing a mobile fuel analysis apparatus comprising:
a vehicle;
a database comprising a near-infrared spectra of standard fuel from a plurality of suppliers; and
a near-infrared spectrometer equipped on the vehicle;
(b) moving the near-infrared spectrometer to a fuel distribution point by the vehicle;
(c) collecting a near-infrared spectrum of a fuel sample from the fuel distribution point; and
(d) comparing the collected spectra to the near-infrared spectra in the database, and converting the collected spectra into corresponding quality parameters, wherein the database comprises near-infrared spectra converted from quality parameters of the standard fuels measured by ethanol content analysis methods, and both the gasoline and diesel are measured by only one near-infrared spectrometer.

13. A method for determining fuel quality comprising:
(a) providing a fuel analysis apparatus comprising:
a database comprising near-infrared spectra of standard fuel from a plurality of suppliers; and
a near-infrared spectrometer equipped on the vehicle;
(b) moving the near-infrared spectrometer to a fuel distribution point by the vehicle;
(c) collecting a near-infrared spectrum of an fuel sample from the fuel distribution point, wherein the fuel sample comprises gasoline and diesel; and
(d) comparing the collected spectra to the near-infrared spectra in the database, and converting the collected spectra into corresponding quality parameters, wherein the database comprises near-infrared spectra converted from quality parameters of the standard fuels selected from the group consisting of sulfur, density, flash point, distillation, cetane index, research octane number, benzene, methylbenzene, and ethanol content, and dissolved oxygen is measured by respective analysis methods, and both the gasoline and diesel are measured by only one near-infrared spectrometer.

14. A mobile fuel analysis apparatus comprising:
a vehicle;
a database comprising near-infrared spectra of standard fuels from a plurality of suppliers, wherein the standard fuels comprise gasoline and diesel; and
a near-infrared spectrometer equipped on the vehicle, wherein both the gasoline and diesel are measured by only one near-infrared spectrometer.

15. The mobile fuel analysis apparatus as claimed in claim 14, wherein the vehicle comprises car, van or truck

16. The mobile fuel analysis apparatus as claimed in claim 14, wherein the database comprises near-infrared spectra converted from quality parameters of the standard fuels measured by analysis methods in a conventional laboratory.

17. The mobile fuel analysis apparatus as claimed in claim 14, wherein the analysis methods comprises sulfur, density, flash point, distillation, cetane index, research octane number, benzene, methylbenzene, ethanol content, and dissolved oxygen analysis.

18. The mobile fuel analysis apparatus as claimed in claim 14, wherein fuel tested comprises gasoline fuel or diesel fuel.

19. The mobile fuel analysis apparatus as claimed in claim 14 further comprising a shockproof device for the near-infrared spectrometer.

20. The mobile fuel analysis apparatus as claimed in claim 19, wherein the shockproof device comprises a base for holding the near-infrared spectrometer, and a plurality of shock absorbers underneath the base.
